(19) United States
(12) Patent Application Publication
(10) Pub. No.: US 2013/0171435 A1
(43) Pub. Date: Jul. 4, 2013

(54) Plastic Glazing and Method of Preparing the Same

(71) Applicant: Cheil Industries Inc., Gumi-si (KR)

(72) Inventors: Jun Ho CHI, Uiwang-si (KR); Jong Chan HUR, Uiwang-si (KR); O Sung KWON, Uiwang-si (KR); Dong Geun LEE, Uiwang-si (KR); Hyuck Man KWON, Uiwang-si (KR); Bok Nam JANG, Uiwang-si (KR)

(73) Assignee: CHEIL INDUSTRIES INC., Gumi-si (KR)

(21) Appl. No.: 13/709,126

(22) Filed: Dec. 10, 2012

(30) Foreign Application Priority Data
Dec. 30, 2011 (KR) 10-2011-0147625

(51) Int. Cl. C08G 64/06

(52) U.S. Cl. CPC C08G 64/06
USPC 428/212; 428/412; 427/402; 427/419.2; 427/419.7; 427/419.1

(57) ABSTRACT

A plastic glazing includes a base layer; and a coating layer formed on one surface of the base layer, wherein the base layer includes polycarbonate including a biphenyl group. The biphenyl group is present in an amount of about 10 mol % to about 50 mol % based on the total amount of polycarbonate.

### CROSS-REFERENCE TO RELATED APPLICATIONS

This application claims priority under 35 USC Section 119 to and the benefit of Korean Patent Application No. 10-2011-0147625 filed on Dec. 30, 2011, the entire disclosure of which is incorporated herein by reference.

### FIELD OF THE INVENTION

The present invention relates to a plastic glazing and a method of preparing the same.

### BACKGROUND OF THE INVENTION

Polycarbonate is a representative thermoplastic material having a heat deflection temperature of 135° C. and exhibits a good balance of properties such as transparency, impact resistance, self-extinguishing property, dimensional stability, heat resistance, and the like. Polycarbonate resins are used in a wide range of applications including electric/electronic products, office equipment, automobile components, and the like.

Various attempts have been made to use polycarbonate as a substitute for metal and glass articles in the vehicle industry. Recently, polycarbonate has been proposed as a glazing material for vehicles to provide excellent impact resistance, transparency, and formability. The use of polycarbonate components instead of glass components in a vehicle can lower the center of gravity of the vehicle, which in turn can enable safer driving. In addition, reduction in the weight of the vehicle using polycarbonate can improve fuel efficiency and economic feasibility.

However, in order to use polycarbonate as a candidate material for glass, the polycarbonate should also have scratch resistance and wear resistance. Prior attempts to improved the scratch and wear resistance of polycarbonate have included improving a polycarbonate matrix itself or adding a layer to the polycarbonate to impart functionality to the polycarbonate matrix.

Prior attempts to improve the polycarbonate matrix itself include increasing the molecular weight of polycarbonate and co-extruding the polycarbonate with copolymers. Recently, a polycarbonate resin containing additives for absorbing or blocking visible light or a polycarbonate resin having improved scratch resistance has been proposed for use in glazing applications.

However, despite such improvements in the polycarbonate resin, scratch resistance and wear resistance of polycarbonate for glazing are still largely dependent on a coating liquid applied to the surface of the base. Thus, most techniques for preparing a polycarbonate glazing focus on improving scratch resistance and wear resistance through application of a functional layer, such as an acrylic or silicone coating liquid, to a polycarbonate base.

Adding a functional layer to a polycarbonate can improve the scratch resistance and wear resistance of the glazing material. Still a challenge remains to provide interface stability between the polycarbonate base and the coating layer stacked thereon. The coating layer stacked on the polycarbonate base for improving scratch resistance and wear resistance can be an acrylic or silicon resin, the coefficient of linear thermal expansion of which is 40 cm/cm/° C., which is much less than that of general polycarbonate having a coefficient of linear thermal expansion of 60 to 65 cm/cm/° C. Thus, there is a need to reduce the coefficient of linear thermal expansion of polycarbonate to improve interface stability between the polycarbonate base and the coating layer. This need, however, cannot be easily achieved due to the chemical structure of polycarbonate.

### SUMMARY OF THE INVENTION

The present invention provides a plastic glazing and a method of preparing the same, which can exhibit excellent properties in terms of interface adherence to a coating layer, solvent resistance, reliability, impact resistance, elongation, scratch resistance, and wear resistance. More particularly, the present invention relates to a plastic glazing and a method of preparing the same, which contains a certain amount of biphenyl structure in a base layer to improve interface stability between coating layers, which can thereby provide excellent reliability and solvent resistance.

The plastic glazing includes a base layer; and a coating layer formed on one surface of the base layer, wherein the base layer comprises polycarbonate including a biphenyl group. The biphenyl group is present in an amount of about 10 mol % to about 50 mol % based on the total amount of polycarbonate.

The polycarbonate including a biphenyl group may include repeated structures of Formulae 1 and 2. The repeated structure of Formula 1 and the repeated structure of Formula 2 may be present in a molar ratio of about 50 to about 90:about 10 to about 50.

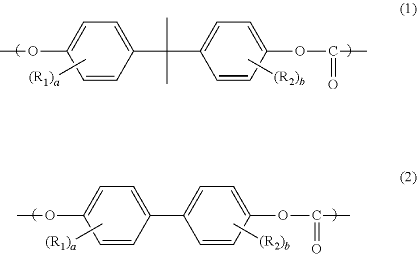

In Formula 1 and 2, R₁ and R₂ are the same or different and are each independently halogen, substituted or unsubstituted C₁ to C₆ alkyl, or substituted or unsubstituted C₆ to C₂₀ aryl, and a and b are the same or different and are each independently an integer from 0 to 4.

The base layer may have a coefficient of linear thermal expansion ranging from about 39 cm/cm/° C. to about 57 cm/cm/° C. for a 6.4 mm flexural specimen measured in accordance with ISO 11359.

The difference in coefficient of linear thermal expansion between the base layer and the coating layer may be about 16 cm/cm/° C. or less.

The coating layer may have a stack structure including a primer layer and a hard coating layer, in which the primer layer contacts the base layer.

The primer layer may include an organopolysiloxane resin, acrylic resin, polyester resin, acrylic-polyester blend resin, or a combination thereof.

The hard coating layer may include a silicone resin, urethane resin, epoxy resin, acrylic resin, polysiloxane resin, polycarbonate grafted polysiloxane resin, or a combination thereof.

The plastic glazing may further include an inorganic material layer formed on the surface of the hard coating layer. The inorganic material layer may include aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxynitride, silicon oxycarbide, hydrogenated silicon oxycarbide, silicon carbide, tantalum oxide, titanium oxide, tin oxide, indium tin oxide, yttrium oxide, zinc oxide, zinc selenide, zinc sulfide, zirconium oxide, zirconium titanate, or a combination thereof.

The present invention also provides a method of preparing a plastic glazing. The method includes forming a base layer using a polycarbonate resin including a biphenyl group; forming a primer layer on a surface of the base layer; and forming a hard coating layer on a surface of the primer layer.

In one embodiment, the method may further include depositing a layer of a compound on a surface of the hard coating layer. The compound can include aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxynitride, silicon oxycarbide, hydrogenated silicon oxycarbide, silicon carbide, tantalum oxide, titanium oxide, tin oxide, indium tin oxide, yttrium oxide, zinc oxide, zinc selenide, zinc sulfide, zirconium oxide, zirconium titanate, or a combination thereof.

### BRIEF DESCRIPTION OF THE DRAWINGS

FIG. 1 is a side sectional view of a plastic glazing according to one embodiment of the present invention; and

FIG. 2 is a partial perspective view of a vehicle to which a plastic glazing according to one embodiment of the present invention is applied.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

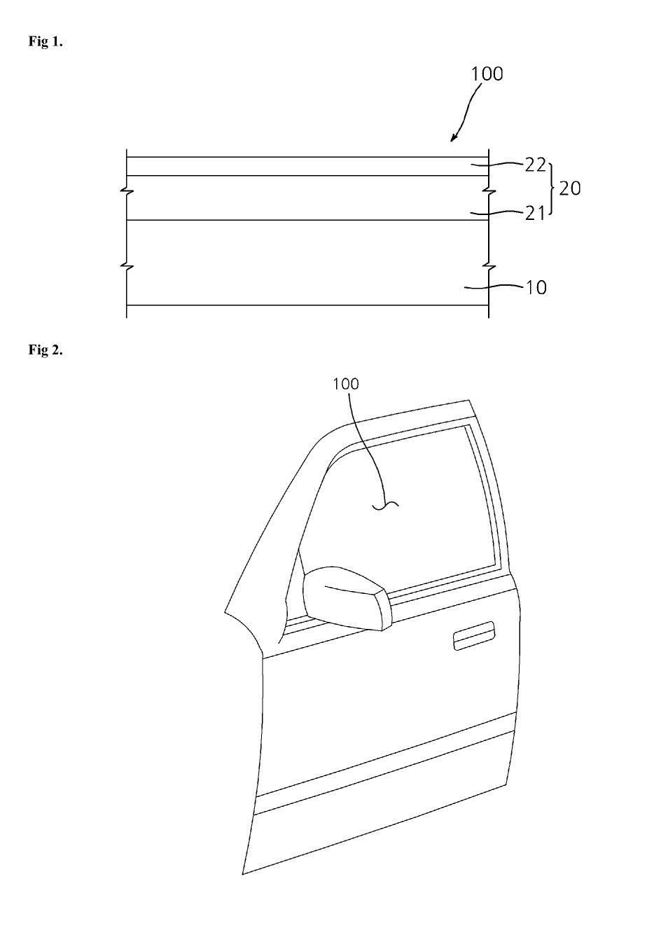

A plastic glazing according to the present invention includes a base layer, and a coating layer formed on one surface of the base layer. FIG. 1 is a side sectional view of a plastic glazing according to one embodiment of the present invention. Referring to FIG. 1, a coating layer 20 is formed on one surface of a base layer 10 and has a stack structure of a primer layer 21 and a hard coating layer 22. The primer layer 21 is interposed between the base layer 10 and the hard coating layer 22.

The plastic glazing according to this embodiment may be prepared by forming a base layer using a polycarbonate resin including a biphenyl group; forming a primer layer on a surface of the base layer; and forming a hard coating layer on a surface of the primer layer. In one embodiment, the primer layer may be formed by coating and curing a primer on the surface of the base layer. Further, the hard coating layer may be formed by coating and curing a hard coating material on the surface of the cured primer layer.

(A) Base Layer

In this invention, the base layer includes a polycarbonate including a biphenyl group. The polycarbonate resin can include the biphenyl group in an amount of about 10 mol % to about 50 mol %, for example about 15 mol % to about 45 mol %, and as another example about 20 mol % to about 40 mol %, based on the total amount of polycarbonate. In some embodiments, the polycarbonate resin can include the biphenyl group in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 mol %. Further, according to some embodiments of the present invention, the amount of the biphenyl group can be in a range from about any of the foregoing amounts to about any other of the foregoing amounts.

If the amount of the biphenyl group is less than about 10 mol %, the base layer can be peeled off and it can be difficult to obtain desired solvent resistance and wear resistance. If the amount of the biphenyl group exceeds about 50 mol %, elongation and impact resistance can rapidly deteriorate.

The polycarbonate including a biphenyl group may include repeated structures of Formulae 1 and 2.

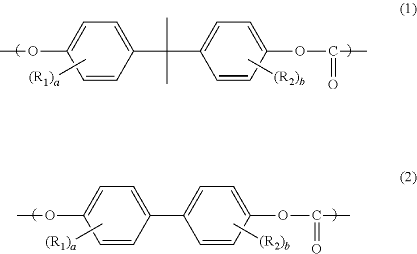

In Formulas 1 and 2, R₁ and R₂ are the same or different and are each independently halogen, substituted or unsubstituted C₁ to C₆ alkyl, or substituted or unsubstituted C₆ to C₂₀ aryl, and a and b are the same or different and are each independently an integer from 0 to 4.

In some embodiments, the polycarbonate containing a biphenyl group may be prepared through transesterification of diols represented by Formulae 1-1 and 2-1 and diaryl carbonate.

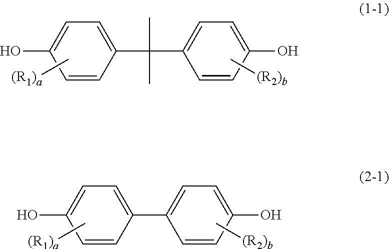

wherein R₁, R₂, a, and b are the same as those defined in Formulae 1 and 2.

Examples of the diol represented by Formula 1-1 include without limitation 2,2-bis-(4-hydroxyphenyl)-propane, 2,2-bis-(3,5-dimethyl-4-hydroxyphenyl)-propane, 2,2-bis-(3,5-diisopropyl-4-hydroxyphenyl)-propane, and the like, and combinations thereof. In exemplary embodiments, 2,2-bis-(4-hydroxyphenyl)-propane called bisphenol-A can be used.

Examples of the diol represented by Formula 2-1 include without limitation 4,4′-biphenol, 2,2′-dimethyl 4,4′-biphenyldiol, 3,3-dimethyl 4,4-dihydroxybiphenyl, 2,2′,6,6′,-tetramethyl-4,4′-biphenol, and the like, and combinations thereof. In exemplary embodiments, 4,4′-biphenol can be used.

In some embodiments, the molar ratio of the diol represented by Formula 1-1 to the diol represented by Formula 2-1 (Formula 1-1: Formula 2-1) may range from about 50 to about 90:about 10 to about 50, for example, from about 55 to about 85:about 15 to about 45, and as another example from about 60 to about 80:about 20 to about 40. In other words, the molar ratio of a repeated structure of Formula 1 and a repeated structure of Formula 2 may range from about 50 to about 90:about 10 to about 50.

In some embodiments, the diol represented by Formula 1-1 may be present in the polycarbonate in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 mol %. Further, according to some embodiments of the present invention, the amount of the diol represented by Formula 1-1 can be in a range from about any of the foregoing amounts to about any other of the foregoing amounts.

In some embodiments, the diol represented by Formula 2-1 may be present in the polycarbonate in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 mol %. Further, according to some embodiments of the present invention, the amount of the diol represented by Formula 2-1 can be in a range from about any of the foregoing amounts to about any other of the foregoing amounts.

When the ratio of the diol represented by Formula 1-1 to the diol represented by Formula 2-1 (Formula 1-1: Formula 2-1) is within the above range, the plastic glazing can have a good balance of properties, such as impact resistance, chemical resistance, interface stability, wear resistance, scratch resistance, and weather resistance.

Examples of diaryl carbonate may include without limitation diphenyl carbonate, ditoryl carbonate, bis(chlorophenyl)carbonate, m-cresyl carbonate, dinaphthyl carbonate, bis(diphenyl)carbonate, diethyl carbonate, dimethyl carbonate, dibutyl carbonate, dicyclohexyl carbonate, and the like. These may be used alone or in combination thereof. In exemplary embodiments, diphenyl carbonate can be used.

In some embodiments, the molar ratio (diol/diaryl carbonate) of the diols represented by Formula 1-1 and Formula 2-1 to the diaryl carbonate may range from about 0.6 to about 1.0, for example from about 0.7 to about 0.9. When the molar ratio (diol/diaryl carbonate) of the diols represented by Formula 1-1 and Formula 2-1 to the diaryl carbonate is within this range, the plastic glazing can exhibit excellent flowability, impact resistance and chemical resistance, and particularly, excellent heat resistance and room temperature impact resistance. In addition, the plastic glazing can secure a low index of refraction and thus can have excellent compatibility with other resins.

In this invention, the base layer may have a coefficient of linear thermal expansion ranging from about 39 cm/cm/° C. to about 57 cm/cm/° C., for example from about 40 cm/cm/° C. to about 50 cm/cm/° C., for a 6.4 mm flexural specimen measured according to ISO 11359. As such, the base layer according to the present invention may provide excellent interface stability between the base layer and the coating layer having a coefficient of linear thermal expansion of about 40 cm/cm/° C. by minimizing difference in the coefficient of linear thermal expansion therebetween. The difference in the coefficient of linear thermal expansion between the base layer and the coating layer can be about 16 cm/cm/° C. or less, for example about 11 cm/cm/° C. or less, preferably about 5 cm/cm/° C. or less.

The base layer typically has a thickness of about 0.1 cm to about 5 cm.

(B) Coating Layer

In this invention, the coating layer has a stack structure of a primer layer and a hard coating layer.

The primer layer serves as a coupling layer between the base layer and the hard coating layer thereon. The primer layer may be formed to a thickness of about 5 μm to about 80 μm by coating a primer on the surface of the base layer comprised of the polycarbonate including a biphenyl group, or by coating and curing the primer thereon through film insert molding or the like. The primer layer may include a single layer or multiple layers. Any material known to those skilled in the art in the art may be used as the material for the primer layer. For example, the primer layer may be formed of an organopolysiloxane resin, acrylic resin, polyester resin, acrylic-polyester blend resin primer, or a combination thereof.

The hard coating layer serves to improve scratch resistance of the base layer. The hard coating layer may be formed to a thickness of about 10 μm to about 100 μm by coating and curing a hard coating material on the surface of the primer layer through bar coating, spray coating, roll coating, flow coating, dip coating, film insert molding, and the like. The hard coating layer may be a single layer or multiple layers. When the hard coating layer has a thickness within this thickness range, the hard coating layer can provide excellent scratch resistance while providing a uniform coating surface.

Examples of the hard coating material may include without limitation silicone resins, urethane resins, epoxy resins, acrylic resins, polysiloxane resins, polycarbonate grafted polysiloxane resins, and the like, and combinations thereof. When the base layer is formed of polycarbonate containing a certain amount of a biphenyl group, the plastic glazing can have further improved properties in terms of scratch resistance, transparency and wear resistance.

Curing may be carried out by heat curing or UV curing. Although UV curing is suited for products having small sizes, heat curing can be used with larger products.

After curing, a stack structure including the base layer, the primer layer and the hard coating layer sequentially stacked therein is formed. For example, a preform can be prepared as the base layer by molding a polycarbonate resin including a biphenyl group, and then the primer layer and the hard coating layer can be sequentially formed on the base layer, thereby forming the stack structure. The preform comprised of the polycarbonate resin including a biphenyl group may be obtained by any typical molding method, such as injection molding, extraction molding, and the like. In exemplary embodiments, the preform can be formed by injection molding. The primer layer may be formed by coating and curing the primer. Further, the hard coating layer may be formed by coating and curing a hard coating material.

In terms of interface stability, the primer layer and the hard coating layer can have a coefficient of linear thermal expansion from about 30 cm/cm/° C. to about 50 cm/cm/° C., for example from about 32 cm/cm/° C. to about 40 cm/cm/° C. In addition, difference in coefficient of linear thermal expansion between the primer layer and the hard coating layer can be about 5 cm/cm/° C. or less, for example about 3 cm/cm/° C. or less, and as another example about 0 cm/cm/° C., to provide excellent dimensional stability. The skilled artisan will appreciate that reference to “about 0 cm/cm/° C.” can include no difference (i.e., zero difference) or some difference slightly greater than zero.

In order to further improve scratch resistance, the coating layer may further include an inorganic material layer on the surface of the hard coating layer. Examples of the inorganic material layer may include without limitation aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxynitride, silicon oxycarbide, hydrogenated silicon oxycarbide, silicon carbide, tantalum oxide, titanium oxide, tin oxide, indium tin oxide, yttrium oxide, zinc oxide, zinc selenide, zinc sulfide, zirconium oxide, zirconium titanate, and the like, and combinations thereof.

The inorganic material layer may be formed by any method known on the art, such as vapor deposition, sputtering, plasma chemical deposition, sol-gel coating, coating, plasma polymerization, and the like. Further, the inorganic material layer may be a single layer or multiple layers.

The plastic glazing according to the present invention can exhibit excellent properties in terms of interface stability between the base layer and the coating layer, wear resistance, scratch resistance, reliability, weather resistance, solvent resistance, elongation and impact resistance, and the like. Thus, the plastic glazing according to this invention may be advantageously applied to vehicles. FIG. 2 is a partial perspective view of a vehicle to which a plastic glazing according to one embodiment of the present invention is applied. In FIG. 2, the plastic glazing is illustrated as being applied to a side window of the vehicle, but may be applied to front and rear windows thereof.

Next, the present invention will be explained in more detail with reference to examples and comparative examples. These examples are provided for illustration only and are not to be in any way construed as limiting the present invention. A description of details apparent to those skilled in the art will be omitted herein.

### EXAMPLE

### Example 1

4.28 kg (18.7 mol) of 2,2-bis(4-hydroxyphenyl)propane (bisphenol A), 0.39 kg (2.1 mol) of 4,4′-biphenyl, 4.64 kg (21.6 mol) of diphenyl carbonate, 150 ppb of KOH (for 1 mol bisphenol A) are sequentially added to a reactor, followed by removal of oxygen from the reactor using nitrogen. The reactor is heated to 160° C. and heated again to 190° C. and kept there for 6 hours. The reactor is heated again to 210° C. and kept there at 100 Torr for 1 hour. The reactor is heated to 260° C. and kept there at 20 Torr for 1 hour, and then kept at 0.5 Torr for 1 hour. 0.03 phr of an antioxidant and 0.05 phr of a phosphorous-based heat stabilizer are added to a molten polymer, and uniformly stirred for about 10 minutes.

The prepared polycarbonate resin is extruded at 270° C. through a twin-screw extruder (L/D=36, φ=32) and formed into pellets using a pelletizer. A 3.0 mm thick specimen (15 mm×15 mm) is obtained using the pellets through an injection machine (DHC 120WD, Donshin Hydraulic Pressure Co., Ltd., 120 ton) at a molding temperature of 270° C. and a mold temperature of 90° C. On the specimen, a primer (Momentive AS4000) containing 2% of solid is deposited to a thickness of about 60 μm at room temperature and then cured. Then, a silicone hard coating material (Momentive AS4700) containing 20% of solid is coated to a thickness of 15 μm thereon by flow coating, followed by curing using a UV lamp. Then, a 0.5 μm thick silicon dioxide layer is formed thereon to prepare a polycarbonate glazing sample. The coating layer has an average coefficient of linear thermal expansion of 40 cm/cm/° C.

### Examples 2 to 5

The samples are prepared using the same method as in Example 1 except that the molar ratio of 2,2-bis(4-hydroxyphenyl)propane (bisphenol A) to 4,4′-biphenyl is changed as shown in the following Table 1.

### Comparative Example 1

4.76 kg of 2,2-bis(4-hydroxyphenyl)propane (bisphenol A), 4.64 kg of diphenyl carbonate, and 150 ppb of KOH (for 1 mol bisphenol A) are sequentially added to a reactor, followed by removal of oxygen from the reactor using nitrogen. The subsequent process is carried out using the same method as in Example 1.

### Comparative Examples 2 to 3

The samples are prepared using the same method as in Example 1 except that the molar ratio of 2,2-bis(4-hydroxyphenyl)propane (bisphenol A) to 4,4′-biphenyl is changed as shown in the following Table 1.

TABLE 1

| | | Example | | | | | Comparative Example | | |
|---|---|---|---|---|---|---|---|---|---|
| | | 1 | 2 | 3 | 4 | 5 | 1 | 2 | 3 |
| Molar ratio | BPA | 90 | 80 | 70 | 60 | 50 | 100 | 95 | 40 |
| between BPA and | BP | 10 | 20 | 30 | 40 | 50 | — | 5 | 60 |
| BP in base layer | | | | | | | | | |

Evaluation of Physical Properties

(1) Coefficient of linear thermal expansion (cm/cm/° C.): The coefficient of linear thermal expansion is measured using a 6.4 mm flexural specimen in a temperature zone of −30 to 110° C. according to ISO 11359.

(2) Wear resistance testing: Variation of haze (AHaze) is measured for a sample having a size of 10×10 cm after 1000 cycles of wear testing under a load of 500 g using a CS-10F wheel by a Taber wear test method according to ASTM D1044.

(3) Pencil hardness: Pencil hardness is measured under a load of 500 g by the method according to ASTM D3363.

(4) Reliability: Cracking or peeling of a sample having a size of 10×10 cm is observed through visual inspection on a cut surface thereof after evaluation under the following conditions.

(i) The sample is left at 50° C. and relative humidity (RH) of 95% for 400 hours.

(ii) The sample is left in boiling water at 100° C. for 2 hours.

(iii) Thermal cycling evaluation (maintaining at −30° C. for 1 hour, followed by heating to 80° C. and maintaining for 1 hour, 5 cycles)

(5) Tape adhesive test: Peeling of a film from a sample having a size of 10×10 cm is observed using a 3M tape according to ASTM D3359. (O: No peeling, X: Peeling occurred)

(6) Solvent resistance: A sample having a size of 10×10 cm is dipped into alcohol and gasoline at room temperature for 24 hours, followed by observation of transmittance (Tᵢₙᵢₜᵢₐₗ/T_{after}>95%).

⊚: Very good, ∘: Good, Δ: Insufficient, X: Very insufficient

(7) Impact strength (kgf·cm/cm): A ⅛″ Izod specimen is made using an non-coated base layer and evaluated at room temperature according to ASTM D256.

(8) Elongation (%): A tensile specimen is made using a non-coated base layer and evaluated according to ASTM D638.

TABLE 2

| | | Example | | | | | Comparative Example | | |
|---|---|---|---|---|---|---|---|---|---|
| | | 1 | 2 | 3 | 4 | 5 | 1 | 2 | 3 |
| Coefficient of linear | | 56 | 51 | 47 | 42 | 39 | 60 | 58 | 35 |
| thermal expansion of | | | | | | | | | |
| base layer | | | | | | | | | |
| Coefficient of linear | | 40 | 40 | 40 | 40 | 40 | 40 | 40 | 40 |
| thermal expansion of | | | | | | | | | |
| coating layer | | | | | | | | | |
| Wear resistance (Haze) | | 18 | 17 | 17 | 16 | 15 | 20 | 20 | 14 |
| Pencil hardness | | 5H | 6H | 6H | 6H | 6H | 5H | 5H | 6H |
| Reliability | (i) | OK | OK | OK | OK | OK | Peeled | Partially | OK |
| | | | | | | | | Peeled | |
| | (ii) | OK | OK | OK | OK | OK | | | OK |
| | (iii) | OK | OK | OK | OK | OK | | | OK |

| | | | | | | | | |
|---|---|---|---|---|---|---|---|---|
| Tape adhesive test | ◯ | ◯ | ◯ | ◯ | ◯ | X | ◯ | ◯ |
| Solvent resistance | ⊚ | ⊚ | ⊚ | ⊚ | ⊚ | Δ | Δ | ⊚ |
| Impact resistance | 70 | 65 | 60 | 55 | 50 | 80 | 77 | 25 |
| Elongation (%) | 105 | 95 | 85 | 75 | 70 | 110 | 105 | 30 |

As shown in Table 1, Examples 1 to 5 exhibit improved interface stability by minimizing the difference in coefficient of linear thermal expansion between the base and the hard coating layer. In contrast, for Comparative Example 1 in which conventional polycarbonate is used, peeling occurred. For Comparative Examples 2 and 3 in which the amount of the biphenyl group is not within the inventive range, the plastic glazing has poor reliability or significantly deteriorated impact resistance and elongation.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A plastic glazing comprising: a base layer; and a coating layer formed on one surface of the base layer,
wherein the base layer comprises polycarbonate including a biphenyl group, wherein the biphenyl group is present in an amount of about 10 mol % to about 50 mol % based on the total amount of polycarbonate.

2. The plastic glazing according to claim 1, wherein the polycarbonate including a biphenyl group comprises repeated structures of Formulae 1 and 2, and the repeated structure of Formula 1 and the repeated structure of Formula 2 are present in a molar ratio of about 50 to about 90:about 10 to about 50. 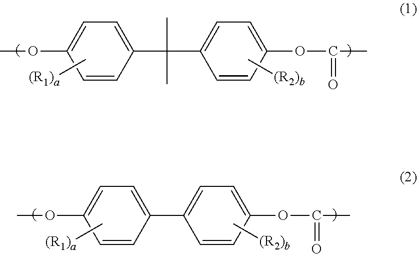
wherein in Formulas 1 and 2, R₁ and R₂ are the same or different and are each independently halogen, substituted or unsubstituted C₁ to C₆ alkyl, or substituted or unsubstituted C₆ to C₂₀ aryl, and a and b are the same or different and are each independently an integer from 0 to 4.

3. The plastic glazing according to claim 1, wherein the base layer has a coefficient of linear thermal expansion ranging from about 39 cm/cm/° C. to about 57 cm/cm/° C. for a 6.4 mm flexural specimen according to ISO 11359.

4. The plastic glazing according to claim 1, wherein difference in coefficient of linear thermal expansion between the base layer and the coating layer is about 16 cm/cm/° C. or less.

5. The plastic glazing according to claim 1, wherein the coating layer has a stack structure of a primer layer and a hard coating layer, in which the primer layer contacts the base layer.

6. The plastic glazing according to claim 1, wherein the primer layer comprises organopolysiloxane resin, acrylic resin, polyester resin, acrylic-polyester blend resin, or a combination thereof.

7. The plastic glazing according to claim 1, wherein the hard coating layer comprises silicone resin, urethane resin, epoxy resin, acrylic resin, polysiloxane resin, polycarbonate grafted polysiloxane resin, or a combination thereof.

8. The plastic glazing according to claim 5, further comprising an inorganic material layer formed on a surface of the hard coating layer.

9. The plastic glazing according to claim 8, wherein the inorganic material comprises aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxynitride, silicon oxycarbide, hydrogenated silicon oxycarbide, silicon carbide, tantalum oxide, titanium oxide, tin oxide, indium tin oxide, yttrium oxide, zinc oxide, zinc selenide, zinc sulfide, zirconium oxide, zirconium titanate, or a combination thereof.

10. A method of preparing plastic glazing comprising:
forming a base layer using a polycarbonate resin including a biphenyl group;
forming a primer layer on a surface of the base layer; and
forming a hard coating layer on a surface of the primer layer.

11. The method according to claim 10, further comprising: forming a layer of a compound on a surface of the hard coating layer.

12. The method according to claim 11, wherein the compound comprises aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxynitride, silicon oxycarbide, hydrogenated silicon oxycarbide, silicon carbide, tantalum oxide, titanium oxide, tin oxide, indium tin oxide, yttrium oxide, zinc oxide, zinc selenide, zinc sulfide, zirconium oxide, zirconium titanate, or a combination thereof.

13. The method according to claim 10, wherein the biphenyl group is present in an amount of about 10 mol % to about 50 mol % based on the total amount of polycarbonate.

14. The method according to claim 10, wherein the polycarbonate including a biphenyl group comprises repeated structures of Formulae 1 and 2, and the repeated structure of Formula 1 and the repeated structure of Formula 2 are present in a molar ratio of about 50 to about 90:about 10 to about 50. 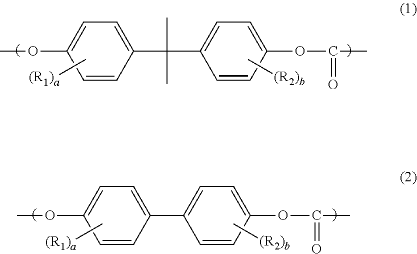
wherein in Formulas 1 and 2, R₁ and R₂ are the same or different and are each independently halogen, substituted or unsubstituted C₁ to C₆ alkyl, or substituted or unsubstituted C₆ to C₂₀ aryl, and a and b are the same or different and are each independently an integer from 0 to 4.

15. The method according to claim 10, wherein the base layer has a coefficient of linear thermal expansion ranging from about 39 cm/cm/° C. to about 57 cm/cm/° C. for a 6.4 mm flexural specimen according to ISO 11359.

16. The method according to claim 10, wherein difference in coefficient of linear thermal expansion between the base layer and the coating layer is about 16 cm/cm/° C. or less.
